(19) United States
(12) Patent Application Publication
(10) Pub. No.: US 2015/0166042 A1
(43) Pub. Date: Jun. 18, 2015

(54) Hybrid Vehicle Driving Device

(71) Applicants: Takeshi Kitahata, Toyota-shi (JP); Tooru Matsubara, Toyota-shi (JP); Atsushi Tabata, Okazaki-shi (JP); Tatsuya Imamura, Okazaki-shi (JP); Kenta Kumazaki, Toyota-shi (JP); Yasuhiro Hiasa, Nagoya-shi (JP); Hiroyuki Shioiri, Numazu-shi (JP); Hiroyuki Shibata, Odawara-shi (JP)

(72) Inventors: Takeshi Kitahata, Toyota-shi (JP); Tooru Matsubara, Toyota-shi (JP); Atsushi Tabata, Okazaki-shi (JP); Tatsuya Imamura, Okazaki-shi (JP); Kenta Kumazaki, Toyota-shi (JP); Yasuhiro Hiasa, Nagoya-shi (JP); Hiroyuki Shioiri, Numazu-shi (JP); Hiroyuki Shibata, Odawara-shi (JP)

(73) Assignee: TOYOTA JIDOSHA KABUSHIKI KAISHA, Toyota-shi, Aichi (JP)

(21) Appl. No.: 14/407,694

(22) PCT Filed: Jun. 15, 2012
(86) PCT No.: PCT/JP2012/065393

§ 371 Date: Dec. 12, 2014

(51) Int. Cl. B60W 20/00; B60W 10/12; B60W 10/08; B60W 30/188; B60W 10/06

(52) U.S. Cl. CPC B60W 20/10; B60W 30/188; B60W 10/06; B60W 10/08; B60W 10/12; Y10S 903/93

(57) ABSTRACT

A hybrid vehicle driving device includes: an engine; a rotation machine; and a transmission unit configured to connect and disconnect the engine and the rotation machine, wherein when the engine is stopped while a vehicle travels by using the engine as a power source, the engine is stopped by the rotation machine in a state in which the gear stage of the transmission unit is fixed, and then the transmission unit is set to a neutral state after the engine is stopped. It is desirable that the hybrid vehicle driving device stop the engine by the rotation machine in a state in which the corresponding relation between a rotation angle of the engine and a rotation angle of the rotation machine is already learned.

### FIELD

The present invention relates to a hybrid vehicle driving device.

### BACKGROUND

Hitherto, there is known a hybrid vehicle including a transmission that transmits a rotation of an engine while changing the rotation speed thereof. For example, Patent Literature 1 discloses a technique of a hybrid vehicle driving device including a transmission mechanism which transmits a rotation of an internal combustion engine to a power deriding mechanism while changing the rotation speed thereof, a first transmission shaft which transmits power from the internal combustion engine to the transmission mechanism, and a second transmission. shaft which transmits power output from the transmission mechanism to the power deviding mechanism.

### CITATION LIST

### Patent Literature

Patent Literature 1: Japanese Patent Application Laid-open No. 2009-190694

### SUMMARY

### Technical Problem

In the hybrid vehicle including the transmission, the appropriate stop of the engine was riot sufficiently examined in the related art. For example, it is desirable to contrive a technique capable of improving the start-up performance when the engine is restarted and suppressing the shock generated when the engine is restarted by stopping the engine at an appropriate rotation angle.

An object of the invention is to provide a hybrid vehicle driving device capable of stopping an engine at an appropriate rotation angle.

### Solution to Problem

A hybrid vehicle driving device according to the invention includes an engine; a rotation machine; and a transmission unit configured to connect and disconnect the engine and the rotation machine, wherein when the engine is stopped while a vehicle travels by using the engine as a power source, the engine is stopped by the rotation machine in a state in which a gear stage of the transmission unit is fixed, and the transmission unit is set to a neutral state after the engine is stopped.

In the hybrid vehicle driving device, it is preferable that the engine is stopped by the rotation machine in a state in which a corresponding relation between a rotation angle of the engine and a rotation angle of the rotation machine is already learned.

In the hybrid vehicle driving device, it is preferable that a torque of the rotation machine is controlled so that a time until the engine stops is the same regardless of the gear stage of the transmission unit.

In the hybrid vehicle driving device, it is preferable that the engine and the rotation machine are connected to each other through a differential mechanism, and when it is possible to stop the engine without magnitude of the differential. rotation speed of the differential mechanism exceeding a predetermined value, the engine is stopped by the rotation machine in the state in which the gear stage of the transmission unit is fixed.

### Advantageous Effects of Invention

The hybrid vehicle driving device according to the invention has an effect that the engine may be stopped at an appropriate rotation angle.

### BRIEF DESCRIPTION OF DRAWINGS

FIG. 1 is a flowchart illustrating he operation of a hybrid vehicle driving device according to an embodiment.

FIG. 2 is a skeleton diagram of the vehicle according to the embodiment.

FIG. 3 is a diagram illustrating an input/output relation of the vehicle according to the embodiment.

FIG. 4 is a diagram illustrating an operation engagement table of the hybrid vehicle driving device according to the embodiment.

FIG. 5 is an alignment chart according to a single motor EV mode.

FIG. 6 is an alignment chart according to a dual motor EV mode.

FIG. 7 is an alignment chart according to an HV low mode.

FIG. 8 is an alignment chart according to an HV high mode.

FIG. 9 is a diagram illustrating a map according to the selection of a mode of the embodiment.

FIG. 10 is a diagram illustrating an operating range of an engine rotation speed decrease control.

FIG. 11 is a time chart according to the operation of the hybrid vehicle driving device of the embodiment.

FIG. 12 is a skeleton diagram of a vehicle according to a modified example of the embodiment.

FIG. 13 is a diagram illustrating an operation engagement table of the hybrid vehicle driving device according to the modified example of the embodiment.

### DESCRIPTION OF EMBODIMENTS

Hereinafter, a hybrid vehicle driving device according to an embodiment of the invention will be described in detail with reference to the drawings. Furthermore, the invention is not limited to the embodiments, Further, components in the following embodiments include a component which may be easily supposed by the person skilled in the art or substantially the same component.

### Embodiment

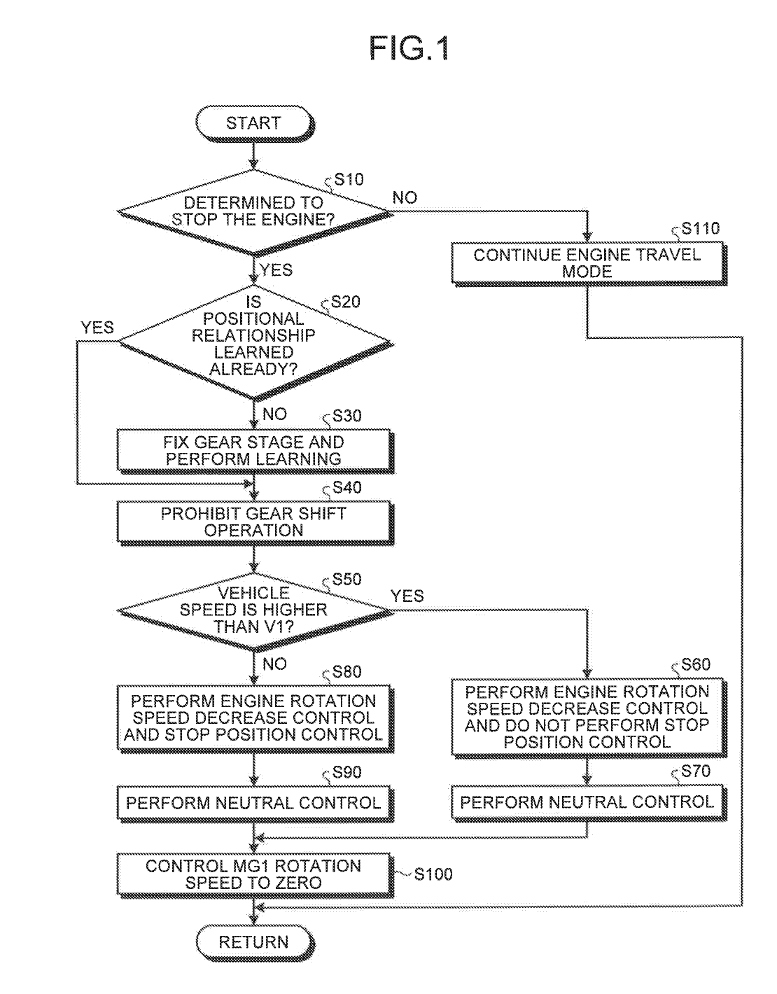

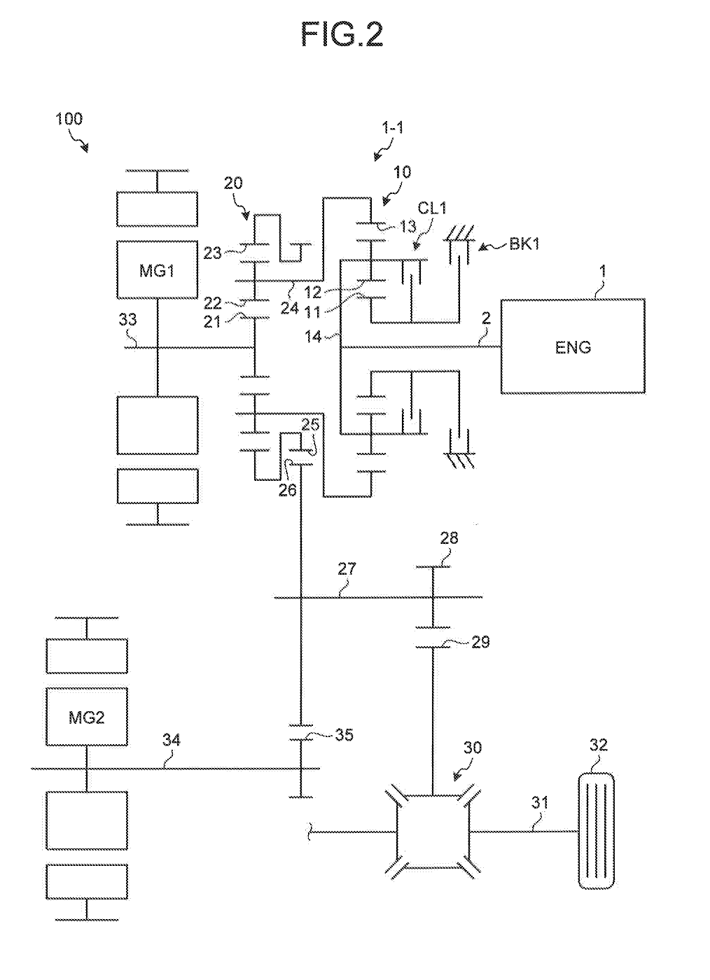

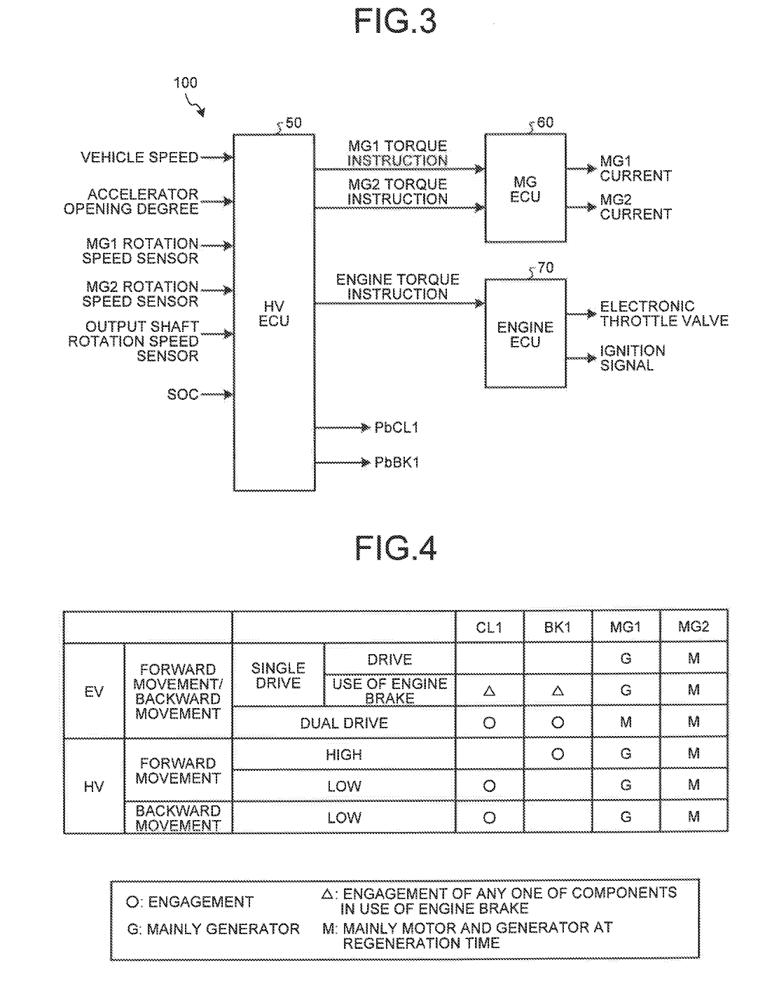

An embodiment will be described with reference to FIGS. 1 to 11. The embodiment relates to a hybrid vehicle driving device. FIG. 1 is a flowchart illustrating the operation of a hybrid vehicle driving device according to the embodiment of the invention, FIG. 2 is a skeleton diagram of the vehicle according to the embodiment, FIG. 3 is a diagram illustrating an input/output relation of the vehicle according to the embodiment, and FIG. 4 is a diagram illustrating en operation engagement table of the hybrid vehicle driving device according to the embodiment.

As illustrated in FIG. 2, a vehicle 100 according to the embodiment is a hybrid (HV) vehicle including an engine 1, a first rotation machine MG1, and a second rotation machine MG2 as power sources. The vehicle 100 may be a plug in hybrid (PHV) vehicle which may be charged by an external power supply. As illustrated in FIGS. 2 and 3, the vehicle 100 is configured to include the engine 1, a first planetary gear mechanism 10, a second planetary gear mechanism 20, the first rotation machine MG1, the second rotation machine MG2, a clutch CL1, a brake BK1, an HV_ECU 50, an MG_ECU 60, and an engine_ECU 70.

Further, a hybrid vehicle driving device 1-1 according to the embodiment is configured to include the engine 1, the first planetary gear mechanism 10, the second planetary gear mechanism 20, the clutch CL1, and the brake BK1. The hybrid vehicle driving device 1-1 may be configured to further include control devices such as the ECUs 50, 60, and 70. The hybrid vehicle driving device 1-1 may be applied to an FF (front engine/front drive) vehicle or a RR (rear engine/rear drive) vehicle. The hybrid vehicle driving device 1-1 is mounted on the vehicle 100 so that the axial direction becomes the vehicle width direction, for example.

In he hybrid vehicle driving device 1-1 according to the embodiment, a transmission unit is configured to include the first planetary gear mechanism 10, the clutch CL1, and the brake BK1. Further, a differential unit is configured to include the second planetary gear mechanism 20. Further, a switching device which shifts the first planetary gear mechanism 10 is configured to include the clutch CL1 and the brake BK1.

The engine 1 converts the combustion energy of fuel into the rotation of the output shaft, and outputs the rotation. The output shaft of the engine 1 is connected to an input shaft 2. The input shaft 2 is an input shaft of a power transmission device. The power transmission device is configured to include the first rotation machine MG1, the second rotation machine MG2, the clutch CL1, the brake BK1, a differential device 30, and the like. The input shaft 2 is disposed so as to be coaxial with the output shaft of the engine 1 and is disposed on the extension line of the output shaft. The input shaft 2 is connected to a first carrier 14 of the first planetary gear mechanism 10.

The first planetary gear mechanism 10 of the embodiment is mounted on the vehicle 100 as a first differential mechanism which is connected to the engine 1 and transmits the rotation of the engine 1. The first planetary gear mechanism 10 is an input side differential mechanism which is disposed near the engine 1 in relation to the second planetary gear mechanism 20. The first planetary gear mechanism 10 may output the rotation of the engine 1 while changing the rotation speed thereof. The first planetary gear mechanism 10 is of a single pinion type, and includes a first sun gear 11, a first pinion gear 12, a first ring gear 13, and a first carrier 14.

The first ring gear 13 is disposed so as to be coaxial with the first sun gear 11 and is disposed at the outside of the first sun gear 11 in the radial direction. The first pinion gear 12 is disposed between the first sun gear 11 and the first ring gear 13, and engages with the first sun gear 11 and the first ring gear 13. The first pinion gear 12 is rotatably supported by the first carrier 14. The first carrier 14 is connected to the input shaft 2, and rotates along with the input shaft 2. Accordingly, the first pinion gear 12 may rotate (revolve) about the center axis of the input shaft 2 along with the input shaft 2 and may rotate (spin) about the center axis of the first pinion gear 12 while being supported by the first carrier 14.

The clutch CL1 is a clutch device which can connect the first sun gear 11 and the first carrier 14.

The clutch CL1 may be, for example, a friction engagement type clutch, but the invention is not limited thereto. For example, a clutch device such as a meshing type clutch may be used as the clutch CL1. The clutch CL1 is controlled by, for example, a hydraulic pressure so as to be engaged or released. The clutch CL1 in the full engagement state may connect the first sun gear 11 and the first carrier 14 so that the first sun gear 11 and the first carrier 14 rotate together. The clutch CL1 in the full engagement state regulates the differential operation of the first planetary gear mechanism 10. Meanwhile, the clutch CL1 in the released state separates the first sun gear 11 and the first carrier 14 so that the relative rotation between the first sun gear 11 and the first carrier 14 is allowed. That is, the clutch CL1 in the released state allows the differential operation of the first planetary gear mechanism 10. Furthermore, the clutch CL1 may be controlled in a half engagement state. The clutch CL1 in the half engagement state allows the differential operation of the first planetary gear mechanism 10.

The brake BK1 is a brake device which can regulate the rotation of the first sun gear 11. The brake BK1 includes an engagement component which is connected to the first sun gear 11 and an engagement component which is connected to a vehicle body, for example, the casing of the power transmission device. The brake BK1 may be configured as the friction engagement type clutch device similar to the clutch CL1, but the invention is not limited thereto. For example, a clutch device such as a meshing type clutch may be used as the brake BK1. The brake BK1 is controlled by, for example, a hydraulic pressure so as to be engaged or released. The brake BK1 in the full engagement state may connect the first sun gear 11 to the vehicle body so that the rotation of the first sun gear 11 is regulated. Meanwhile, the brake BK1 in the released state separates the first sun gear 11 from the vehicle body so that the rotation of the first sun gear 11 is allowed. Furthermore, the brake BK1 may be controlled in the half engagement state. The brake BK1 in the half engagement state allows the rotation of the first sun gear 11.

The second planetary gear mechanism 20 of the embodiment is mounted on the vehicle 100 as a second differential mechanism which connects the first planetary gear mechanism 10 and a driving wheel 32. The second planetary gear mechanism 20 is an output side differential mechanism which is disposed at the side of the driving wheel 32 in relation to the first planetary gear mechanism 10. The second planetary gear mechanism 20 is of a single pinion type, and includes a second sun gear 21, a second pinion gear 22, a second ring gear 23, and a second carrier 24. The second planetary gear mechanism 20 is disposed so as to be coaxial with the first planetary gear mechanism 10 and is disposed so as to face the engine 1 with the first planetary gear mechanism 10 interposed therebetween.

The second ring gear 23 is disposed so as to be coaxial with the second sun gear 21 and is disposed at the outside of the second sun gear 21 in the radial direction. The second pinion. gear 22 is disposed between the second sun gear 21 and the second ring gear 23, and engages with the second sun gear 21 and the second ring gear 23. The second pinion gear 22 is rotatably supported by the second carrier 24. The second carrier 24 is connected to the first ring gear 13, and rotates along with the first ring gear 13. The second pinion. gear 22 may rotate (revolve) about the center axis of the input shaft 2 along with. the second carrier 24 and may rotate (spin) about the center axis of the second pinion gear 22 while being supported by the second carrier 24. The first ring gear 13 is an output component of the first planetary gear mechanism 10, and may output the rotation which is input from the engine 1 to the first planetary gear mechanism 10, to the second carrier 24. The second carrier 24 corresponds to a first rotation. component connected to the output component of the first planetary gear mechanism 10.

A rotation shaft 33 of the first rotation machine MG1 is connected to the second sun gear 21. The rotation shaft 33 of the first rotation machine MG1 is disposed so as to be coaxial with the input shaft 2 and rotates along with the second sun gear 21. The second sun gear 21 corresponds to a second rotation component connected to the first rotation machine MG1. A counter drive gear 25 is connected to the second ring gear 23. The counter drive gear 25 is an output gear which rotates along with the second ring gear 23. The second ring gear 23 corresponds to a third rotation component which is connected to the second rotation machine MG2 and the driving wheel 32. The second ring gear 23 is en output component which may output the rotation input from the first rotation machine MG1 or the first planetary gear mechanism 10 to the driving wheel 32.

The counter drive gear 25 engages with a counter driven gear 26. The counter driven gear 26 is connected. to a drive pinion gear 28 through a counter shaft 27. The counter driven gear 26 and the drive pinion gear 28 rotate together. Further, a reduction gear 35 engages with the counter driven gear 26. The reduction gear 35 is connected to a rotation shaft 34 of the second rotation machine MG2. That is, the rotation of the second rotation machine MG2 is transmitted to the counter driven gear 26 through the reduction gear 35. The reduction gear 35 has a diameter smaller than that of the counter driven gear 26, and transmits the rotation of the second rotation machine MG2 to the counter driven gear 26 while the rotation speed is decreased.

The drive pinion gear 28 engages with a differential ring gear 29 of the differential device 30. The differential device 30 is connected to driving wheels 32 through left and right drive shafts 31. The second ring gear 23 is connected to the driving wheel 32 through the counter drive gear 25, the counter driven gear 26, the drive pinion gear 28, the differential device 30, and the drive shaft 31. Further, the second rotation machine MG2 is connected to the power transmission path between the second ring gear 23 and the driving wheel 32, and may transmit power to the second ring gear 23 and the driving wheel 32.

Each of the first rotation machine MG1 and the second rotation machine MG2 has a function of a motor (an electric rotating machine) and a function of a generator. The first rotation machine MG1 and the second rotation machine MG2 are connected to a battery through an inverter, The first rotation machine MG1 and the second rotation machine MG2 may output the mechanical power while the electric power supplied from the battery is converted into mechanical power and may convert the mechanical power into electric power while being driven by the power input thereto. The electric power which is generated by the rotation machines MG1 and MG2 may be stored in the battery. As the first rotation machine MG1 and the second rotation machine MG2, for example, an AC synchronization type motor generator may be used.

In the vehicle 100 of the embodiment, the brake BK1, the clutch CL1, the first planetary gear mechanism 10, the counter drive gear 25, the second planetary gear mechanism 20, and the first rotation machine MG1 are disposed in this order from the engine 1 so as to be coaxial with the engine 1. Further, the hybrid vehicle driving device 1-1 of the embodiment is of a multi-axial type in which the input shaft 2 and the rotation shaft 34 of the second rotation machine MG2 are disposed on different axes.

As illustrated in FIG. 3, the vehicle 100 includes the NV_ECU 50, the MG_ECU 60, and the engine_ECU 70. Each of the ECUs 50, 60, and 70 is an electronic control unit including a computer. The HV_ECU 50 has a function of controlling the entire vehicle 100. The MG_ECU 60 and the engine_ECU 70 are electrically connected to the HV_ECU 50,

The MG_ECU 60 may control the first rotation machine MG1 and the second rotation machine MG2. For example, the MG_ECU 60 may control the output torque of the first rotation machine MG1 by adjusting the value of the current supplied to the first rotation machine MG1 and may control the output torque of the second rotation machine MG2 by adjusting the value of the current supplied to the second rotation machine MG2.

The engine_ECU 70 may control the engine 1. For example, the engine ECU 70 may control the opening degree of an electronic throttle valve of the engine 1, may control the ignition of the engine 1 by outputting an ignition signal, and may control the injection of the fuel to the engine 1. The engine_ECU 70 may control the output torque of the engine 1 by the control of the opening degree of the electronic throttle valve, the control of the injection, and the control of the ignition.

A vehicle speed sensor, an accelerator opening degree sensor, an MG1 rotation speed sensor, an MG2 rotation speed sensor, an output shaft rotation speed sensor, a battery sensor, and the like are connected to the HV_ECU 50. By these sensors, the HV_ECU 50 may acquire the vehicle speed, the accelerator opening degree, the rotation speed of the first rotation machine MG1, the rotation speed of the second rotation. machine MG2, the rotation speed of the output shaft of the power transmission device, the battery state SOC, and the like.

The HV_ECU 50 may calculate the required driving force, the required power, the required torque, and the like for the vehicle 100 based on the acquired information. The HV_ECU 50 determines the output, torque of the first rotation machine MG1 (hereinafter, referred to as the “MG1 torque”), the output torque of the second rotation machine MG2 (hereinafter, referred to as the “the MG2 torque”), and the output torque of the engine 1 (hereinafter, referred to as the “engine torque”) based on the calculated required values. The HV_ECU 50 outputs the MG1 torque instruction value and the MG2 torque instruction value to the MG_ECU 60. Further, the HV_ECU 50 outputs the engine torque instruction value to the engine_ECU 70.

The HV_ECU 50 controls each of the clutch CL1 and the brake BK1 based on the travel mode and the like to be described later. The HV_ECU 50 outputs an instruction value (PbCL1) of an oil pressure supplied to the clutch CL1 and an instruction value (PbBK1) of an oil pressure supplied to the brake BK1. The hydraulic control device (not illustrated) controls the oil pressure supplied to the clutch CL1 and the brake BK1 in response to the instruction values PbCL1 and PbBK1.

The vehicle 100 may selectively perform a hybrid (HV) travel mode or an EV travel mode. The HV travel mode indicates a travel mode which causes the vehicle 100 to travel by using the engine 1 as the power source. In the MV travel mode, the second rotation. machine MG2 may be used as the power source in addition to the engine 1.

The EV travel mode is a travel mode which causes the vehicle to travel by using at least one of the first rotation machine MG1 and the second rotation machine MG2 as the power source. In the EV travel mode, the vehicle may travel while the engine 1 is stopped. As the EV travel mode, the hybrid vehicle driving device 1-1 according to the embodiment includes a single motor EV mode (a single drive EV mode) which causes the vehicle 100 to travel by using the second rotation machine MG2 as a single power source and a dual motor EV mode (a dual drive EV mode) which causes the vehicle 100 to travel by using the first rotation machine MG1 and the second rotation machine MG2 as the power sources.

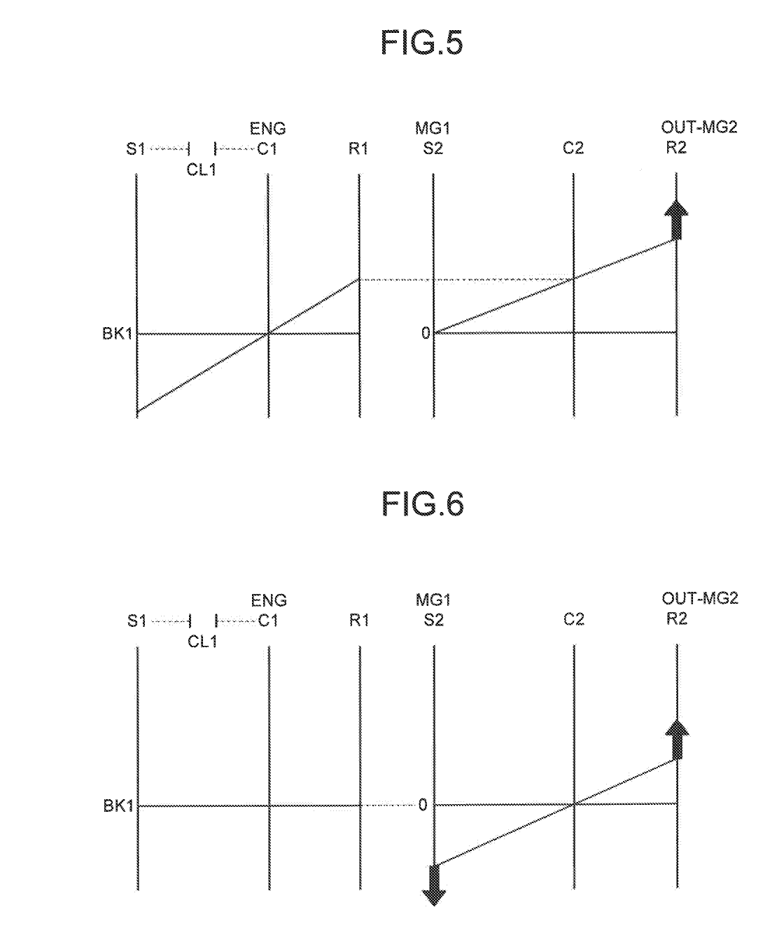

In the engagement table of FIG. 4, the circle of the sections of the clutch CL1 and the brake BK1 indicates the engaged state, and the blank indicates the released state. Further, the triangle indicates a state where any one of the clutch CL1 and the brake BK1 is engaged and the other thereof is released. The single motor EV mode is performed while, for example, both the clutch CL1 and the brake BK1 are released. FIG. 5 is an alignment chart according to the single motor IV mode. In the alignment chart, Reference Signs S1, C1, R1 respectively indicate the first sun gear 11, the first carrier 14, and the first ring gear 13, and Reference Signs S2, C2, and R2 respectively indicate the second sun gear 21, the second carrier 24, and the second ring gear 23.

In the single motor EV mode, the clutch CL1 and the brake BK1 are released. Since the brake BK1 is released, the rotation of the first sun gear 11 is allowed. Since the clutch CL1 is released, the differential operation of the first planetary gear mechanism 10 is allowed. The HV_ECU 50 makes the MG_ECU 60 generating a driving force in the vehicle 100 in the forward moving direction by causing the second rotation machine MG2 to output a positive torque. The second ring gear 23 rotates normally along with the rotation of the driving wheel 32. Here, the normal rotation is set. as the rotation direction of the second ring gear 23 when the vehicle 100 moves forward. The HV_ECU 50 reduces the dragging loss by operating the first rotation machine MG1 as a generator.

Specifically, the HV_ECU 50 generates power by applying a slight torque to the first rotation machine MG1, and sets the rotation speed of the first rotation machine MG1 to zero. Thus, the dragging loss of the first rotation machine MG1 may be reduced. Further, when the MG1 rotation speed can be maintained at zero by using a cogging torque even when the MG1 torque is zero, the MG1 torque may not be applied. Alternatively, the MG1 rotation speed may be set to zero by the d-axis locking of the first rotation machine MG1.

The first ring gear 13 rotates normally along with the second carrier 24. Since the first planetary gear mechanism 10 is in the neutral state where the clutch CL1 and the brake BK1 are released, the engine 1 is not rotated, and the rotation of the first carrier 14 stops.

Accordingly, a large regeneration amount may be obtained. The first sun gear 11 rotates reversely in the idling state. Furthermore, the neutral state of the first planetary gear mechanism 10 is a state where no power is transmitted between the first ring gear 13 and the first carrier 14, that is, the engine 1 and the second planetary gear mechanism 20 are separated from each other so that the transmission of the power is interrupted. When at least one of the transmission clutch CL1 and the transmission brake BK1 engages, a connection state of the first planetary gear mechanism 10 is realized in which the engine 1 is connected to the second planetary gear mechanism 20.

There may be a case where the regeneration energy is not obtained due to the full charge state of the battery when the vehicle travels in the single motor EV mode. In this case, it is considered that an engine brake is used together. When the engine 1 is connected to the driving wheel 32 by the engagement of the clutch CL1 or the brake BK1, the engine brake may be applied to the driving wheel 32. As indicated by the triangle of FIG. 4, when the clutch CL1 or the brake BK1 is engaged in the single motor EV mode, the engine 1 is rotated, and the engine rotation speed is increased by the first rotation machine MG1 so that the engine brake state is realized.

In the dual motor EV mode, the HV_ECU 50 engages the clutch CL1 and the brake BK1. FIG. 6 is an alignment chart according to the dual motor EV mode, Since the clutch CL1 is engaged, the differential operation of the first planetary gear mechanism 10 is regulated. Since the brake BK1 is engaged, the rotation of the first sun gear 11 is regulated. Accordingly, the rotation of all rotation components of the first planetary gear mechanism 10 is stopped. Since the rotation of the first ring gear 13 as the output component is regulated, the rotation speed of the second carrier 24 connected thereto is locked to zero.

The HV_ECU 50 causes each of the first rotation machine MG1 and the second rotation machine MG2 to output a travel driving torque. Since the rotation of the second carrier 24 is regulated, a reaction force is obtained with respect to the torque of the first rotation machine MG1, and hence the torque of the first rotation machine MG1 may be output from the second ring gear 23. The first rotation machine MG1 may output a positive torque from the second ring gear 23 by rotating reversely and outputting a negative torque in the forward travelling. Meanwhile, the first rotation machine MG1 may output a negative torque from the second ring gear 23 by rotating normally and outputting a positive torque in the backward travelling.

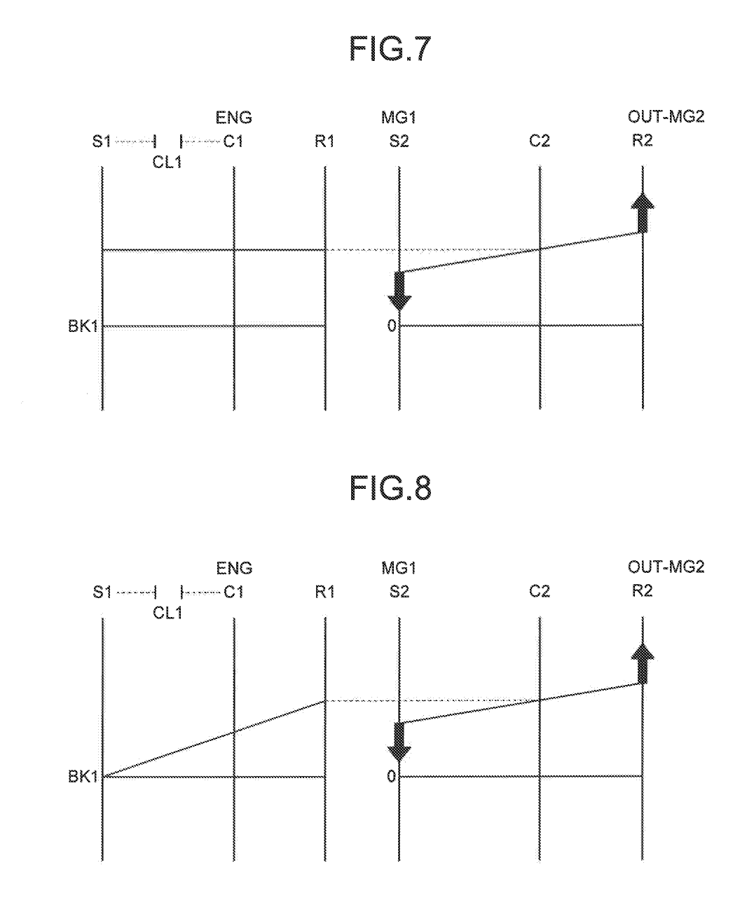

In the HV travel mode, the second planetary gear mechanism 20 as the differential unit is normally in a differential state and the first planetary gear mechanism 10 of the transmission unit is switched to the low/high state. FIG. 7 is an alignment chart according to the HV travel mode in the low state (hereinafter, referred to as the “HV low mode”), and FIG. 8 is an alignment chart according to the HV travel mode in the high state (hereinafter, referred to as the “HV high mode”).

In the HV low mode, the HV_ECU 50 engages the clutch CL1 and releases the brake BK1, Since the clutch CL1 is engaged, the differential operation of the first planetary gear mechanism 10 is regulated, so that the rotation components 11, 13, and 14 rotate together. Accordingly, the rotation of the engine 1 is transmitted from the first ring gear 13 to the second carrier 24 at an equal rotation speed without being increased or decreased.

Meanwhile, in the HV high mode, the HV_ECU 50 releases the clutch CL1 and engages the brake BK1. Since the brake BK1 is engaged, the rotation of the first sun gear 11 is regulated. Accordingly, the first planetary gear mechanism 10 becomes an overdrive (OD) state where the rotation of the engine 1 input to the first carrier 14 is increased in speed and is output from the first ring gear 13. In this way, the first planetary gear mechanism 10 may output the rotation of the engine 1 while increasing the rotation speed thereof. The transmission gear ratio of the first planetary gear mechanism 10 in the overdrive state may be set to, for example, 0.7.

In this way, the switching device including the clutch CL1 and the brake BK1 shifts the first planetary gear mechanism 10 by switching a state where the differential operation of the first planetary gear mechanism 10 is regulated and a state where the differential operation of the first planetary gear mechanism 10 is allowed. The hybrid vehicle driving device 1-1 may switch the HV high mode and the HV low mode by the transmission unit including the first planetary gear mechanism 10, the clutch CL1, and the brake BK1, and may improve the transmission efficiency of the vehicle 100. Further, the second planetary gear mechanism 20 as the differential unit is connected in series to the rear stage of the transmission unit. Since the first planetary gear mechanism 10 is in the overdrive state, there is an advantage that the torque of the first rotation machine MG1 does not need to be a high torque.

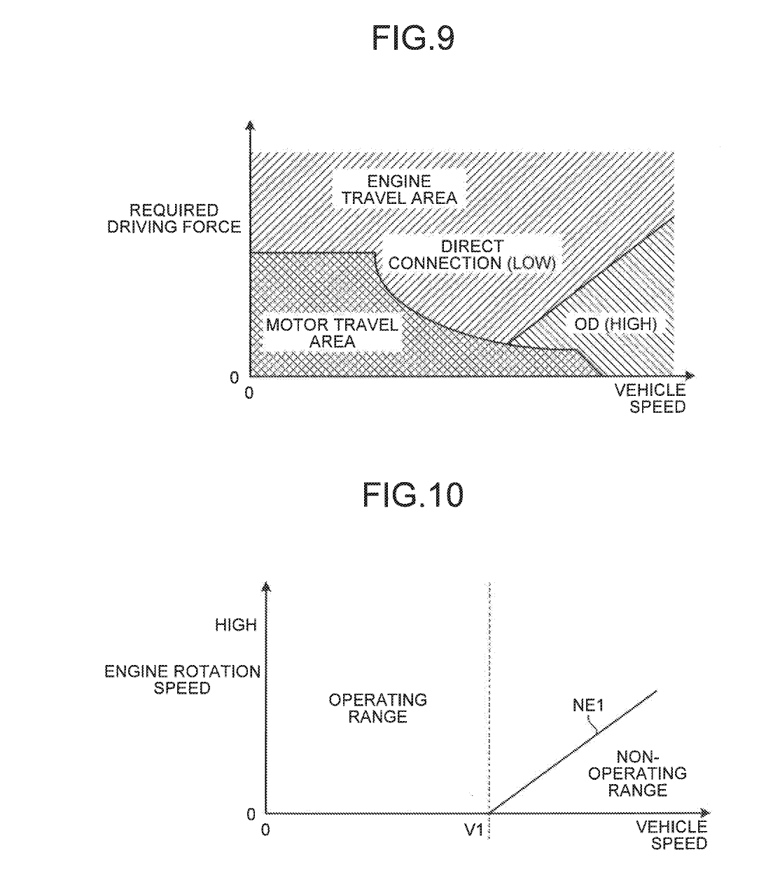

For example, the HV_ECU 50 selects the HV high mode at the high vehicle speed and selects the HV low mode at the middle and low vehicle speeds. FIG. 9 is a diagram illustrating a map according to the selection of the mode of the embodiment. In FIG. 9, the horizontal axis indicates the vehicle speed, and the vertical axis indicates the required driving force. As illustrated in FIG. 9, a motor travel area is an area with low vehicle speed and low-load in which the required driving force is small. In the motor travel area, the EV travel mode is selected. In the motor travel area, for example, the single motor EV mode is selected at the low-load state and the dual drive EV mode is selected at the high-load state.

An area having a high vehicle speed or a high load compared to the motor travel area is an engine travel area. The engine travel area is further divided into a direct connection (low) area and an OD (high) area. The direct connection area is an engine travel area in which the HV low mode is selected. The OD area is an engine travel area in which the HV high mode is selected. The OD area is an area of a high vehicle speed, and the direct connection area is an area of a low/middle vehicle speed. The direct connection area is set to a high load side compared to the OD area. Since the transmission unit is maintained in an overdrive state when the vehicle speed is high and the load is low, the fuel efficiency may be improved.

In the embodiment, since the rotation of the engine 1 is output while the rotation speed thereof is chanced by, the selection of the HV high mode and the HV low mode, two mechanical points exist, and hence the fuel efficiency may be improved. Note that the mechanical point is a highly efficient operation point in which the power input to the planetary gear mechanisms 10 and 20 is entirely transmitted to the counter drive gear 25 through the mechanical transmission without through the electric path.

In the hybrid vehicle driving device 1-1 according to the embodiment, the first planetary gear mechanism 10 may output the rotation of the engine 1 from the first ring gear 13 while increasing the rotation speed thereof. Accordingly, the hybrid vehicle driving device 1-1 includes another mechanical point at the high gear side in relation to the mechanical point obtained in the case where the engine 1 is directly connected to the second carrier 24 without providing the first planetary gear mechanism 10. That is, the hybrid vehicle driving device 1-1 includes two mechanical points at the high gear side. Accordingly, the hybrid vehicle driving device 1-1 may realize a hybrid system that improves the fuel efficiency by improving the transmission efficiency when the vehicle travels at a high speed.

Further, the hybrid vehicle driving device 1-1 may regulate the rotation of the input component of the second planetary gear mechanism 20 by engaging the clutch CL1 and the brake BK1 of the transmission unit, and hence may cause the vehicle to travel in the dual motor EV mode. For this reason, there is no need to provide a separate additional clutch or the like in order to realize the dual motor EV mode, and hence the configuration is simplified. In the layout of the embodiment, a large deceleration ratio of the second rotation machine MG2 may be obtained. Further, a compact arrangement may be realized by the FF or RR layout.

(Backward Travel)

When the vehicle travels backward while the engine is used as a power source, the first rotation machine MG1 generates electric power as a generator, and the second rotation machine MG2 performs a power running operation as a motor outputting a negative torque and rotating reversely. When the battery charging state is sufficient, the vehicle may perform motor travelling in the single drive EV mode in which the second rotation machine MG1 rotates reversely. Further, the vehicle may travel backward in the dual drive EV mode by fixing the second carrier 24.

(Cooperative Gear Shift Control)

When the HV_ECU 50 switches the HV high mode and the HV low mode, a cooperative gear shift, control of simultaneously shifting the first planetary gear mechanism 10 and the second planetary gear mechanism 20 may be Performed. In the cooperative gear shift control, the HV_ECU 50 increases transmission gear ratio of one of the the first planetary gear mechanism 10 and the second planetary gear mechanism 20 and decreases the transmission gear ratio of the other.

When the HV_ECU 50 switches the HV high mode to the HV low mode, the transmission gear ratio of the second planetary gear mechanism 20 is changed to the high gear side in synchronization with the switching of the mode. Thus, it is possible to decrease a change in transmission gear ratio by suppressing or reducing a non-continuous change in the entire transmission gear ratio of the vehicle from the engine 1 to the driving wheel 32. Since a change in the transmission gear ratio from the engine 1 to the driving wheel 32 is suppressed, the engine rotation speed adjustment amount may be decreased or the engine rotation speed does not need to be adjusted in the gear shift operation. For example, the HV_ECU 50 shifts the first planetary gear mechanism 10 and the second planetary gear mechanism 20 in the cooperation state so that the entire transmission gear ratio of the entire vehicle 100 is continuously changed to the low gear side.

Meanwhile, when the HV_ECU 50 switches the HV low mode to the HV high mode, the transmission gear ratio of the second planetary gear mechanism 20 is changed to the low gear side in synchronization with the switching of the mode. Thus, it is possible to decrease a change in transmission gear ratio by suppressing or reducing a non-continuous change in the transmission gear ratio of the entire vehicle 100. For example, the HV_ECU 50 shifts the first planetary gear mechanism 10 and the second planetary gear mechanism 20 in the cooperation state so that the entire transmission gear ratio of the vehicle 100 is continuously changed to the high gear side.

The adjustment of the transmission gear ratio of the second planetary gear mechanism 20 is performed by, for example, the control of the rotation speed of the first rotation machine MG1. For example, the HV_ECU 50 controls the first rotation machine MG1 so that the transmission gear ratio between the input shaft 2 and the counter drive gear 25 is continuously changed. Thus, the entire transmission device including the planetary gear mechanisms 10 and 20, the first rotation machine MG1, the clutch CL1, and the brake BK1, that is, the transmission device including the differential unit and the transmission unit is operated as an electric continuously variable transmission. Since the range of the transmission gear ratio of the transmission device including the differential unit and the transmission unit is wide, the transmission gear ratio from the differential unit to the driving wheel 32 is comparatively large. Further, the circulation of power is reduced when the vehicle travels at the high vehicle speed in the HV travel mode.

(Engine Start-up Control)

In the case where the engine 1 is started from the single motor EV mode, the clutch CL1 or the brake BK1 is engaged, the engine rotation speed is increased by the first rotation machine MG1, and the ignition is performed. At this time, the rotation speed of the second carrier 24 (the first ring gear 13) may be controlled to zero by the control of the rotation speed of the first rotation machine MG1 before the clutch CL1 or the brake BK1 is engaged. Further, a reaction torque is generated in a direction in which the travel driving force is decreased when the engine rotation speed is increased by the MG1 torque. The HV_ECU 50 may cause the second rotation machine MG2 to additionally output a reaction force cancel, torque that cancels the reaction torque. Furthermore, in the case where the engine 1 is a direct injection engine or the like which can start independently, the engine 1 may start independently and the independent start-up of the engine 1 may be assisted by the MG1 torque.

(Engine Stop Control)

When the hybrid vehicle driving device 1-1 according to the embodiment stops the engine 1 while the vehicle travels by using the engine 1 as a power source, the engine 1 is stopped by the first rotation machine MG1 in a state in which the gear stage of the transmission unit is fixed, and the transmission unit is set to a neutral state after the engine 1 is stopped. At this time, an engine stop position control to be described below may be performed while the gear stage is fixed. Since the engine 1 is stopped in the state in which the gear stage is fixed and the gear is not shifted, the engine stop position control may be easily performed.

Note thea an operation of causing the first rotation machine MG1 to stop the engine 1 includes, for example, an operation of causing the first rotation machine MG1 to generate a torque in a direction opposite to the rotation direction of the engine 1 or an operation of causing the first rotation machine MG1 to generate a torque in the rotation direction of the engine 1 after the supply of a fuel to the engine 1 is stopped. Further, an operation of causing the first, rotation machine MG1 to stop the engine 1 includes an operation of changing the engine rotation speed or the rotation angle of the engine 1 by the torque of the first rotation machine MG1 until the engine 1 is stopped.

An operation of fixing the gear stage of the transmission. unit includes an operation of maintaining the current gear stage without changing the gear stage. Further, an operation of fixing the gear stage of the transmission unit includes an operation of fixing the gear stage of the transmission unit at a predetermined gear stage. In this case, if the current gear stage is not a predetermined gear stage, the gear stage is shifted to the predetermined gear stage, and then the gear stage is maintained at the predetermined gear stage.

(Engine Stop Position Control)

When the hybrid, vehicle driving device 1-1 according to the embodiment stops the engine 1, for example, in the HV travel mode, an engine stop position control of controlling the stop position of the engine 1 may be performed. The engine stop position control controls the stop position of the engine 1 by the first rotation machine MG1 in the state in which the gear stage of the transmission unit is fixed so that the engine 1 is stopped at a predetermined crank angle. The predetermined crank angle is set to, for example, a crank angle at which the shock generated when the engine 1 is restarted next time may be minimized. For example, the predetermined crank angle is a crank angle at which the reaction force generated by the air in the cylinder when the engine 1 starts to rotate for a restart is minimized. Since the reaction force with respect to the rotation is small, the engine rotation speed increases fast. As a result, the shock caused by the start-up is suppressed since the engine rotation speed increases passing through the rotation speed area of the oscillation point of the engine 1 fast when the engine 1 restarts. As an example, the predetermined crank angle is set to a crank angle at which the piston is stopped in the expansion state during the expansion cycle or a crank angle at which the piston is stopped in the compression. state during the compression cycle.

(Engine Rotation Speed Decrease Control)

Further, the hybrid vehicle driving device 1-1 may perform an engine rotation speed decrease control. The engine rotation speed decrease control is a control of promoting a decrease in the engine rotation speed when the engine 1 is stopped during the HV travel mode or the like. Specifically, a decrease in the engine rotation speed is promoted by causing the first rotation machine MG1 to output a torque (a negative torque) in a direction in which the rotation of the engine is regulated. Due to the engine rotation speed decrease control, the engine rotation speed decreases passing through the rotation speed area of the oscillation point. of the engine 1 fast when the engine 1 stops. Thus, the engine stop shock is suppressed. Further, in the engine rotation speed decrease control, the first rotation machine MG1 serves as a generator by rotating normally and generating a negative torque. Accordingly, in the engine rotation speed decrease control, the rotation energy of the engine 1 may be recycled as the electric energy and charged to the battery.

Here, in the case where the engine stop position control is performed, the differential rotation speed of the second planetary gear mechanism 20 increases as the engine rotation speed decreases and the vehicle speed increases. Here, the differential rotation speed indicates the rotation speed of the second pinion gear 22. The large differential rotation speed is not desirable in that the large differential rotation speed leads to degradation in efficiency or the like. The hybrid vehicle driving device 1-1 of the embodiment performs the engine stop position control when the differential rotation speed of the second planetary gear mechanism 20 becomes a predetermined value or less. Here, the “case where the differential rotation speed of the second planetary gear mechanism 20 becomes a predetermined value or less” indicates, for example, the case where it is estimated that the differential rotation speed of the second planetary gear mechanism 20 until the rotation of the engine 1 is stopped by the engine stop position control does not exceed, a predetermined value. Since the engine stop position control is not performed. when the differential rotation speed of the second planetary gear mechanism 20 exceeds the predetermined value, it is possible to suppress the differential rotation speed of the second planetary gear mechanism 20 from becoming an excessively large value.

The predetermined value with respect to the differential rotation speed of the second planetary gear mechanism 20 is determined based on, for example, the maximum value which is allowed at the differential rotation speed of the second planetary gear mechanism 20. The predetermined value is determined from the viewpoint of, for example, the loss generated by the second planetary gear mechanism 20 or the durability of the second planetary gear mechanism 20.

FIG. 10 is a diagram illustrating the operating range of the engine rotation speed decrease control. In FIG. 10, the horizontal axis indicates the vehicle speed, and the vertical axis indicates the engine rotation speed. As illustrated in FIG. 10, when the vehicle speed is a predetermined vehicle speed V1 or less, the differential rotation speed of the second planetary gear mechanism 20 does not become larger than a predetermined value even when the engine rotation. speed decrease control is performed until the engine rotation speed becomes zero. Accordingly, when the vehicle speed is the predetermined vehicle speed V1 or less, the HV_ECU 50 performs the engine rotation speed decrease control and the engine stop position control. The HV_ECU 50 causes the first rotation machine MG1 to decrease the engine rotation speed, and causes the first rotation machine MG1 to control the rotation angle of the engine 1 so that the crank angle of the engine 1 becomes a predetermined crank angle when the engine 1 stops.

Meanwhile, when the vehicle speed exceeds the predetermined vehicle speed V1, the engine stop position control is not performed. The HV_ECU 50 ends the engine rotation speed decrease control when the engine rotation speed decreases to a predetermined rotation speed NE1. The predetermined vehicle speed V1 of the embodiment is set as a vehicle speed at which the differential rotation speed of the second planetary gear mechanism 20 becomes a predetermined upper limit value. When the rotation speed of the first rotation machine MG1 is changed in synchronization with the engine rotation speed until the engine 1 is stopped when the vehicle speed is higher than the predetermined vehicle speed V1, the differential rotation speed of the second planetary gear mechanism 20 exceeds a predetermined value. The predetermined rotation speed NE1 indicates the engine rotation speed at which the differential rotation speed of the second planetary gear mechanism 20 becomes a predetermined value when the rotation speed of the first rotation machine MG1 is changed by the engine rotation speed decrease control or the engine stop position control in synchronization with the engine rotation speed.

The HV_ECU 50 releases the clutch CL1 and the brake BK1 so that the transmission unit becomes a neutral state in an area where the engine rotation speed is smaller than the predetermined rotation speed NE1. When the transmission unit is set to the neutral state, the power transmission between the engine 1 and the first rotation machine MG1 or the second rotation machine MG2 is interrupted. Accordingly, when the transmission unit becomes the neutral state, there is no need to change the rotation speed of the first rotation machine MG1 in synchronization with a decrease of the engine rotation speed. Thus, it is possible to suppress an excessive increase in the differential rotation speed of the planetary gear mechanisms 10 and 20.

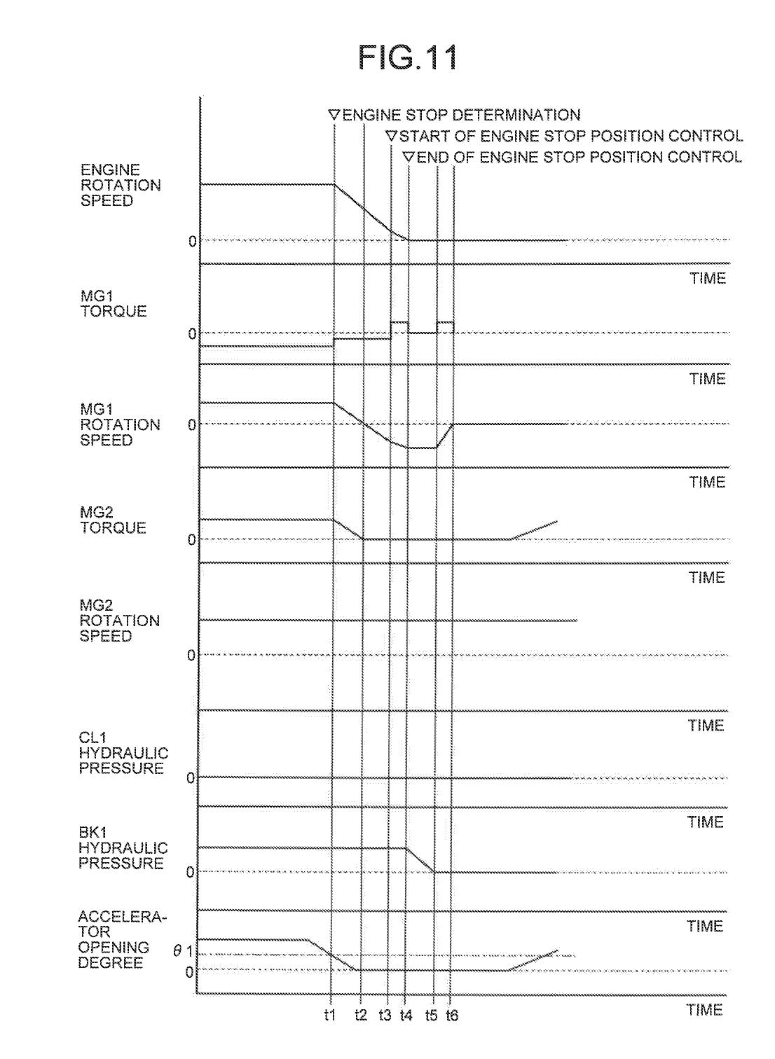

Referring to FIGS. 1 and 11, the operation of the hybrid vehicle driving device 1-1 of the embodiment will be described. The control flow illustrated in FIG. 1 is performed while the vehicle 100 travels, for example, at a predetermined interval. FIG. 11 is a time chart according to the operation of the hybrid vehicle driving device 1-1 of the embodiment.

In step S10, the HV_ECU 50 determines whether an engine stop determination is performed. The HV_ECU 50 determines whether a condition of stopping the engine 1 is satisfied during the vehicle travels in the HV mode which uses the engine 1 as a power source. For example, the engine stop determination is performed when the operation point changes from the engine travel area to the motor travel area based on the map illustrated in FIG. 9. In FIG. 11, the engine stop determination is performed at the time t1 at which the accelerator opening degree decreases to θ1, and a positive determination is performed in step S10. When the engine stop determination is performed, the HV_ECU 50 performs a fuel-cut that stops the supply of a fuel to the engine 1. The MG1 torque after the time t1 is changed from the reaction torque with respect to the engine torque until then to the torque that decreases the engine rotation speed. The HV_ECU 50 causes the first rotation machine MG1 to output a negative torque so as to promote a decrease of the engine rotation speed.

When it is determined that the engine stop determination is performed (step S10-Y) as the determination result of step S10, the routine proceeds to step S20. Meanwhile, when it is determined that the engine stop determination is not performed (step S10-N), the routine proceeds to step S110.

In step S20, the HV_ECU 50 determines whether the positional relationship is already learned (a state where the origin is adjusted). The positional relationship is the positional relationship between the crank angle of the engine 1 and the rotation angle of the first rotation machine MG1. In the hybrid vehicle driving device 1-1 of the embodiment, the engine 1 and the first rotation machine MG1 are connected to each other through the transmission unit. For this reason, when the transmission unit is set to the neutral state or the transmission unit is shifted, a deviation occurs in the corresponding relation between the crank angle of the engine 1 and the rotation angle of the first rotation machine MG1. In this case, there is a need to learn the positional relationship again.

The hybrid vehicle driving device 1-1 includes a sensor which detects the crank angle of the engine 1 and a sensor (for example, the MG1 rotation speed sensor) which detects the rotation angle of the first rotation machine MG1. The HV_ECU 50 may learn the positional relationship based on the detection result of the sensors. in the learning control, for example, the phase difference between the origin of the crank angle and the origin of the rotation angle of the first rotation machine MG1 is learned. The learning of the positional relationship is appropriately performed in the state where the learning of the positional relationship is not yet performed. For example, the learning of the positional relationship is performed when the transmission unit is shifted from the neutral state to any gear stage or the gear shift operation thereof is performed.

When it is determined that the learning of the positional relationship is already learned (step S20-Y) as the determination result. of step S20, the routine proceeds to step S40. Meanwhile, when it is determined that the learning of the positional relationship is not yet learned (step S20-N), the routine proceeds to step S30.

In step S30, the HV_ECU 50 performs the learning by fixing the gear stage. The HV_ECU 50 learns the relation between the crank angle of the engine 1 and the rotation angle of the first rotation machine MG1 in the state in which the gear stage of the transmission unit is fixed by prohibiting the gear shift operation of the transmission unit. For example, when the engine stop determination is performed during the gear shift operation, the gear stage is set first and the angle relation is learned. That is, the relation between the crank angle of the engine 1 and the rotation angle of the first rotation machine MG1 is learned in the state in which the gear stage of the transmission unit is fixed to the gear stage of the NV low mode or the gear stage of the HV high mode. By the learning, the rotation angle of the first rotation machine MG1 and the crank angle may be correlated to each other, and hence the engine stop position control of stopping the engine 1 at a desired crank angle can be performed by the rotation control of the first rotation machine MG1. When the learning of step S30 is completed, the routine proceeds to step S40.

In step S40, the NV_ECU 50 prohibits the Gear shift operation. The HV_ECU 50 prohibits the gear shift operation of the transmission unit so that the corresponding relation between the crank angle and the rotation angle of the first rotation machine MG1 does not change from the learned relation.

Next, in step S50, the HV_ECU 50 determines whether the vehicle speed is higher than the predetermined vehicle speed V1. When it is determined that the vehicle speed is higher than the predetermined vehicle speed V1 (step S50-Y) as the determination result, the routine proceeds to step S60. Meanwhile, when it is determined that the vehicle speed. is not higher than the predetermined vehicle speed V1 (step S50-N), the routine proceeds to step S80.

In step S60, the HV_ECU 50 performs the engine rotation speed decrease control and does not perform the engine stop position control. The HV_ECU 50 performs the engine rotation speed decrease control so as to promote a decrease of the engine rotation speed by the first rotation machine MG1. When the engine rotation speed decreases to the predetermined rotation speed NE1, the routine proceeds to step S70.

In step S70, the HV_ECU 50 performs a neutral control. The HV_ECU 50 sets the transmission unit to the neutral state by releasing the clutch CL1 and the brake BK1. When the transmission unit becomes the neutral state, the routine proceeds to step S100.

In step S80, the HV_ECU 50 performs each of the engine rotation speed decrease control and the engine stop position control. The HV_ECU 50 promotes a decrease in the engine rotation speed by the engine rotation speed, decrease control. In FIG. 11, the engine rotation speed decrease control is started at the time t1. The HV_ECU 50 controls the stop position of the engine 1 by the first rotation machine MG1 so that the engine 1 is stopped at a predetermined crank angle when the rotation of the engine 1 stops. The engine stop position control is started, for example, when the engine rotation speed becomes a predetermined rotation speed or less. In FIG. 11, the engine stop position control is started at the time t3.

The HV_ECU 50 sets an engine rotation speed decrease rate at the engine stop position, control to be smaller than the engine rotation speed decrease rate at the engine rotation speed decrease control. For example, the HV_ECU 50 decreases the engine rotation speed decrease rate by setting the MG1 torque to a positive torque at the engine stop position control. The HV_ECU 50 controls the rotation angle of the engine 1 by the MG1 torque so that the engine 1 is stopped at a predetermined crank angle, The engine stop position control ends when the engine 1 is stopped at the predetermined crank angle. The HV_ECU 50 sets the MG1 torque to zero when the engine stop position control ends. In FIG. 11, the engine stop position. control ends at the time t4. When the engine stop position control ends, the routine proceeds to step S90.

In step S90, the HV_ECU 50 performs a neutral control. The HV_ECU 50 sets the transmission unit to the neutral state by releasing the clutch CL1 and the brake BK1. That is, the transmission unit is set to the neutral state after the engine 1 is stopped. In FIG. 11, the oil pressure supplied to the brake BK1 engaged so far decreases at the time t4, so that the brake BK1 is released. The clutch CL1 and the brake BK1 are all released until the time t5. When the transmission unit becomes the neutral state, the routine proceeds to step S100.

In step S100, the HV_ECU 50 performs a control in which the rotation speed of the first rotation machine MG1 is set to zero. The neutral control is performed in step S70 or step S90, and the rotation speed of the first rotation machine MG1 can be changed regardless of be engine rotation speed. The HV_ECU 50 changes the rotation speed of the first rotation machine MG1 to zero. For example, the rotation of the first rotation machine MG1 may be stopped by causing the first rotation machine MG1 which rotates reversely to output a positive torque. Alternatively, the rotation of the first rotation machine MG1 may be stopped by the friction by causing the first rotation machine MG1 to idle instead of outputting the positive torque. In FIG. 11, the rotation speed of the first rotation machine MG1 changes to zero from the time t5 to the time t6. When the process of step S100 is performed, this control flow ends.

A series of control according to the stop of the engine is completed by the process of step S100, and hence the travel mode is completely switched to the motor travel mode. When the accelerator opening degree increases in the motor travel mode, the HV_ECU 50 causes the second rotation machine MG2 to output the MG2 torque and makes the vehicle 100 travelling by using the motor as a drive source.

When a negative determination is performed in step S10 and the routine proceeds to step S110, the HV_ECU 50 continues to cause the vehicle to travel by using the engine as a drive source in step S110. The HV_ECU 50 continuously operates the engine 1 so that the vehicle 100 travels in the MV low mode or the HV high mode. When the process of step S110 is performed, this control flow ends.

As described above, the hybrid vehicle driving device 1-1 of the embodiment sets the transmission unit to the neutral state after the engine stop position control by the first rotation machine MG1 is completed when the engine 1 is stopped. Thus, the engine 1 may be stopped at an appropriate rotation angle. Accordingly, it is possible to improve the start-up performance of the engine 1 or reduce the shock when the engine is restarted.

Further, the hybrid vehicle driving device 1-1 stops the engine 1 by the first rotation machine MG1 in the state in which the learning of the corresponding relation between the crank angle of the engine 1 and the rotation angle of the first rotation machine MG1 is already performed. Desirably, the engine stop position control is performed. when the engine 1 is stopped. Thus, the stop position control for the crank angle may be performed with high precision.

Further, when the engine stop determination is performed during the gear shift operation, the angle relation is learned after setting the gear stage in the transmission unit, and then the engine stop position control is performed. Accordingly, the engine 1 may be stopped at a desired crank angle.

Further, the hybrid vehicle driving device 1-1 does not perform the engine stop position control when the engine stop determination is performed at the vehicle speed higher than the predetermined vehicle speed V1. Thus, it is possible to suppress an excessive increase in the pinion counter rotation speed (the differential rotation speed) of the second planetary gear mechanism 20. Further, when the engine stop determination is performed at the vehicle speed equal to or lower than the predetermined vehicle speed V1, the engine 1 is stopped by the first rotation machine MG1 in the state in which, the gear stage of the transmission unit is fixed. Thus, it is possible to stop the engine 1 while suppressing an excessive increase in the pinion counter rotation speed (the differential rotation speed) of the second planetary gear mechanism 20. It is desirable to perform the engine stop position control, by the first rotation machine MG1 when the engine 1 is stopped.

Further, the engine rotation speed decrease control is performed until the engine rotation speed decreases to the predetermined rotation speed NE1. Accordingly, since the engine rotation speed decreases passing through the rotation speed area of the oscillation point fast, the vibration generated when the engine is stopped is reduced.

Further, the transmission unit is set to the neutral state after the engine rotation speed decrease control or the engine stop position control is completed, and the MG1 rotation speed is set to zero. Thus, degradation in efficiency caused by the friction or the like of the first rotation machine MG1 is suppressed.

Note that the MG1 torque may be changed in response to the gear stage of the transmission unit in the engine rotation speed decrease control or the engine stop position control. For example, the MG1 torque is set so that the time until the rotation of the engine 1 stops after a judgment of stopping the engine 1 becomes the same time regardless of the gear stage. As an example, the MG1 torque may be set so that the engine rotation speed decrease rate becomes constant regardless of the gear stage. Since the engine stop time is set to be constant, it is possible to reduce the uncomfortable feeling of the driver.

Further, in the case where the engine 1 is a supercharged engine, the engine rotation speed decrease control or the engine stop position control may be performed after the supercharging pressure decreases. Thus, since the compression reaction force of the engine may be decreased, the vibration generated when the engine is stopped is reduced.

### MODIFIED EXAMPLE OF EMBODIMENT

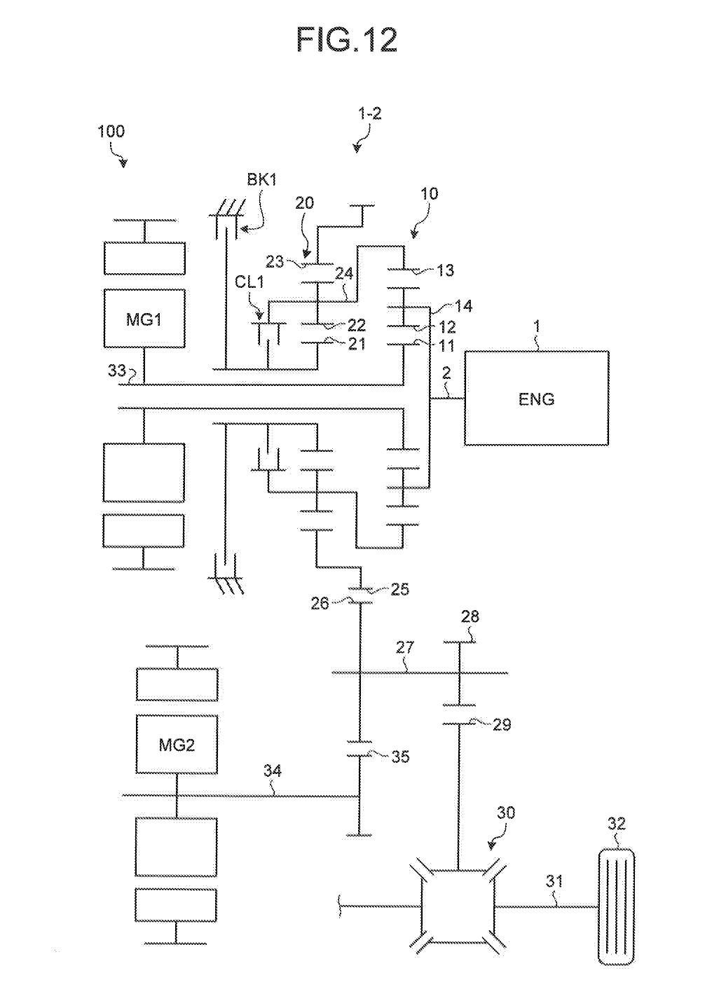

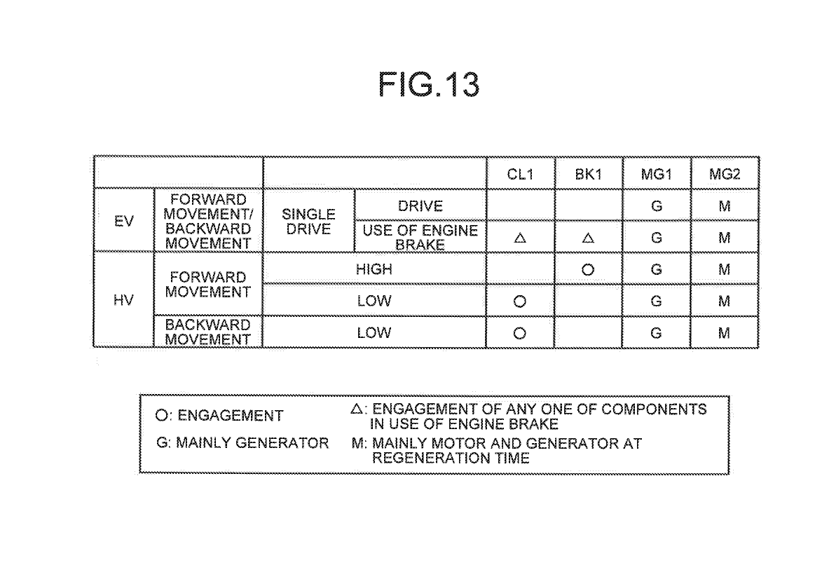

A modified example of the embodiment will be described. FIG. 12 is a skeleton diagram of the vehicle according to the modified example of the embodiment, and FIG. 13 is a diagram illustrating the operation engagement table of the hybrid vehicle driving device according to the modified example of the embodiment. The hybrid vehicle driving device 1-2 of the modified example is different from the hybrid vehicle driving device 1-1 of the embodiment in that the second planetary gear mechanism 20 serves as a transmission unit.

As illustrated in FIG. 12, the first carrier 14 of the first planetary gear mechanism 10 is connected to the engine 1 and the first ring gear 13 is connected to the second carrier 24 of the second planetary gear mechanism 20 as in the embodiment. A rotation shaft 33 of the first rotation machine MG1 is connected to the first sun gear 11 of the first planetary gear mechanism 10. Accordingly, the first planetary gear mechanism 10 may serve as a power dividing mechanism. which divides the output torque of the engine 1 among the first rotation machine MG1 side and the output side. Further, the first planetary gear mechanism 10 may serve as a differential unit capable of continuously changing the rotation speed ratio between the engine 1 (the first carrier 14) and the first ring gear 13, along with the first rotation machine MG1.

As in the embodiment, the counter drive gear 25 is connected to the second ring gear 23 of the second planetary gear mechanism 20. The brake BK1 is connected to the second sun gear 21. The brake BK1 is a brake device capable of regulating the rotation of the second sun gear 21. The brake BK1 of the modified example may have the same configuration. as the brake BK1 of the embodiment.

The clutch CL1 according to the modified example is a clutch device capable of connecting the second sun gear 21 and the second carrier 24 to each other. The clutch CL1 of the modified example may have the same configuration as the clutch CL1 of the embodiment. The switching device including the clutch CL1 and the brake BK1 shifts the second planetary gear mechanism 20 by switching between the state where the differential operation of the second planetary gear mechanism 20 is regulated and the state where the differential operation of the second planetary gear mechanism 20 is allowed. That is, the second planetary gear mechanism 20 of the modified example serves as a transmission unit.

As illustrated in FIG. 13, the hybrid vehicle driving device 1-2 of the modified example does not include the dual motor EV mode differently from the hybrid vehicle driving device 1-1 (see FIG. 4) of the embodiment. The engagement/released states of the clutch CL1 and the brake BK1 in the other modes are the same as those of the embodiment.

In the hybrid vehicle driving device 1-2 according to the modified example, the power transmission path between the first ring gear 13 and the driving wheel 32 is interrupted when the brake BK1 and the clutch CL1 are released and the transmission unit is a neutral state. In this case, the power transmission between the engine 1 and the first rotation machine MG1 is also interrupted. In the single motor EV mode, the vehicle may travel by using the second rotation machine MG2 as a power source by releasing the brake BK1 and the clutch CL1 so that the second rotation machine MG2 and the driving wheel 32 are separated from the engine 1.

Meanwhile, when the brake BK1 or the clutch CL1 is engaged, the power transmission path between the first ring gear 13 and the driving wheel 32 is connected. For example, when the brake BK1 is engaged and the clutch CL1 is released (the HV high mode), the rotation of the second sun gear 21 is regulated. Thus, the first ring gear 13 is connected to the driving wheel 32 through the second carrier 24, the second pinion gear 22, and the second ring gear 23 so that power may be transmitted. Accordingly, the first rotation machine MG1 is connected to the engine 1 so that power may be transmitted. The first rotation machine MG1 serves as a reaction force receiving portion for the engine 1, and hence may output an engine torque from the first ring gear 13 to the driving wheel 32. Since the brake BK1 is engaged, the rotation of the engine which is input to the second carrier 24 is increased in rotation speed and output from the second ring gear 23.

When the brake BK1 is released and the clutch CL1 is engaged (the HV low mode), the differential. operation of the second planetary gear mechanism 20 is regulated. Thus, the first ring gear 13 is connected to the driving wheel 32 through the second carrier 24, the second pinion gear 22, and the second ring gear 23 so that power may be transmitted. Accordingly, the first rotation machine MG1 is connected to the engine 1 so that power may be transmitted. The first rotation machine MG1 serves as a reaction force receiving portion for the engine 1, and hence may output the engine torque from the first ring gear 13 to the driving wheel 32. Since the clutch CL1 is engaged, the rotation of the engine which is input to the second carrier 24 is output from the second ring gear 23 without being increased or decreased in rotation speed.

The hybrid vehicle driving device 1-2 according to the modified example performs the engine rotation speed decrease control or the engine stop position control as in the hybrid vehicle driving device 1-1 of the embodiment. Here, when the second planetary gear mechanism 20 as the transmission unit is set to the neutral state or the transmission unit is shifted, a deviation occurs in the corresponding relation between the crank angle of the engine 1 and the rotation, angle of the first rotation machine MG1. The HV_ECU 50 of the modified example may perform the same control (see FIG. 1) as the HV_ECU 50 of the embodiment. When the learning of the positional relationship is not yet. learned (S20-N), the learning is performed in the state in which the gear stage is fixed (S30), and then the engine stop position control is performed (S30). Further, when the differential, rotation speed of the first planetary gear mechanism 10 becomes a predetermined value or less (S50-N), the engine stop position control is performed.

In the embodiment and the modified example, there is disclosed the power transmission device (the hybrid vehicle driving device) “including: the engine; the first transmission unit; and the differential unit, wherein an electric continuously variable transmission unit is configured by the first rotation machine (the electric rotating machine) and the second rotation machine (the electric rotating machine), and wherein the first transmission unit is set to the neutral state after the engine stop position control is completed by the rotation machine”. According to the power transmission device, it is possible to reduce the shock generated when the engine 1 restarts by improving the precision of the stop position control.

The contents disclosed in the embodiment and the modified, example may be appropriately combined with one another.

### REFERENCE SIGNS LIST

1-1, 1-2 Hybrid Vehicle Driving Device
1 Engine
10 First Planetary Gear Mechanism
20 Second Planetary Gear Mechanism
100 Vehicle
Mg1 First Rotation Machine
Mg2 Second Rotation Machine

1. A hybrid vehicle driving device comprising:
an engine;
a rotation machine; and
a transmission unit configured to connect and disconnect the engine and the rotation machine, wherein
when the engine is stopped while a vehicle travels by using the engine as a power source, the engine is stopped by the rotation machine in a state in which a gear stage of the transmission unit is fixed, and the transmission unit is set to a neutral state after the engine is stopped.

2. The hybrid vehicle driving device according to claim 1, wherein
the engine is stopped by the rotation machine in a state in which a corresponding relation between a rotation angle of the engine and a rotation angle of the rotation machine is already learned.

3. The hybrid vehicle driving device according to claim 1, wherein
a torque of the rotation machine is controlled so that a time until the engine stops is the same regardless of the gear stage of the transmission unit.

4. The hybrid vehicle driving device according to claim 1, wherein
the engine and the rotation machine are connected to each other through a differential mechanism, and
when it is possible to stop the engine without magnitude of the differential rotation speed of the differential mechanism exceeding a predetermined value, the engine is stopped by the rotation machine in the state in which the gear stage of the transmission unit is fixed.

5. The hybrid vehicle driving device according to claim 2, wherein
a torque of the rotation machine is controlled so that the time until the engine stops is the same regardless of the gear stage of the transmission unit.
